(19) United States
(12) Patent Application Publication
(10) Pub. No.: US 2008/0015754 A1
(43) Pub. Date: Jan. 17, 2008

(54) System for estimating and compensating for lateral disturbances using controlled steering and braking

(76) Inventor: Aleksander B. Hac, Dayton, OH (US)

Correspondence Address: Delphi Technologies, Inc., Legal Staff - M/C 480-410-202, P.O. Box 5052, Troy, MI, 48007-5052, US

(21) Appl. No.: 11/486,941

(22) Filed: Jul. 14, 2006

(51) Int. Cl. G06F 17/00

(52) U.S. Cl. 701/48; 701/1

(57) ABSTRACT

A method for compensating for a lateral force disturbance acting on a vehicle including the steps of estimating a magnitude of the lateral force disturbance, determining whether the magnitude or a rate of change of the magnitude exceeds a predetermined threshold value and, when the predetermined threshold value is exceeded, generating a control signal adapted to at least partially counter the lateral force disturbance.

### BACKGROUND

The present application relates to systems and methods for estimating and compensating for lateral disturbances and, more particularly, to systems and methods for estimating and compensating for lateral disturbances without the need for optical sensors.

Lateral disturbances of significant strength (e.g., a gust of side wind or a sudden change of the bank angle of the road) may cause a vehicle to deviate from the intended lane if the driver does not react quickly. Automatic lane tracking systems have been developed and typically employ cameras, lasers or other optical systems to determine the lateral position of the vehicle relative to the road. In response to the lateral position signals, such systems may warn the driver and/or provide automatic steering corrections. However, such systems are expensive and in many cases provide little or no control authority.

Accordingly, there is a need for a system and method for estimating and compensating for lateral disturbances without the need for optical sensors.

### SUMMARY

In one aspect, a method for compensating for a lateral force disturbance acting on a vehicle includes the steps of estimating a magnitude of the lateral force disturbance, determining whether the magnitude or a rate of change of the magnitude exceeds a predetermined threshold value and, when the predetermined threshold value is exceeded, generating a control signal adapted to at least partially counter the lateral force disturbance.

In another aspect, a method for compensating for a lateral force disturbance acting on a vehicle includes the steps of estimating a lateral velocity of the vehicle based upon at least one of a measured lateral acceleration, a yaw rate, a front wheel steering angle, a rear wheel steering angle and a vehicle speed, based at least upon the estimated lateral velocity, estimating a magnitude and a direction of the lateral force disturbance acting on the vehicle, determining whether the magnitude or a rate of change of the magnitude exceeds a predetermined threshold value and, when the predetermined threshold value is exceeded, providing the vehicle with at least one of a steering correction and a brake intervention to at least partially counter the magnitude and direction of the lateral force disturbance.

Other aspects of the disclosed estimation and compensation system and method will become apparent from the following description, the accompanying drawings and the appended claims.

### BRIEF DESCRIPTION OF THE DRAWINGS

FIG. 1 is a schematic illustration of a vehicle subjected to a crosswind;

FIG. 2a is a graphical illustration of aerodynamic side force versus time of a vehicle during straight driving at 120 kph with side winds of 40 kph occurring at 2 seconds;

FIG. 2b is a graphical illustration of aerodynamic moment versus time of the vehicle of FIG. 2a;

FIG. 2c is a graphical illustration of lateral acceleration versus time of the vehicle of FIG. 2a;

FIG. 2d is a graphical illustration of yaw rate versus time of the vehicle of FIG. 2a;

FIG. 3a is a graphical illustration of aerodynamic side force versus time of a vehicle during straight driving at 120 kph with side winds of 80 kph occurring at 2 seconds;

FIG. 3b is a graphical illustration of aerodynamic moment versus time of the vehicle of FIG. 3a;

FIG. 3c is a graphical illustration of lateral acceleration versus time of the vehicle of FIG. 3a;

FIG. 3d is a graphical illustration of yaw rate versus time of the vehicle of FIG. 3a;

FIG. 4 is a schematic illustration of a vehicle on a road bank;

FIG. 5 is a flowchart illustrating one aspect of the disclosed system and method for estimating and compensating for lateral disturbances;

FIG. 6a is a graphical illustration of actual and estimated lateral velocities versus time of a simulated vehicle traveling at 120 kph in response to a 80 kph crosswind occuring after 2 seconds with the estimate obtained by applying the disclosed system and method for estimating lateral velocity;

FIG. 6b is a graphical illustration of actual and estimated aerodynamic side force versus time of the vehicle of FIG. 6a with the estimate obtained by applying the disclosed system and method for estimating lateral disturbances;

FIG. 7a is a graphical illustration of lateral acceleration versus time of a simulated vehicle traveling at 120 kph in response to a 80 kph crosswind occuring after 2 seconds for a conventional vehicle and a vehicle applying the disclosed system and method for estimating and compensating the lateral disturbances using the front steering input;

FIG. 7b is a graphical illustration of yaw rate versus time of the vehicle of FIG. 7a;

FIG. 7c is a graphical illustration of lateral deviation versus time of the vehicle of FIG. 7a; and

FIG. 7d is a graphical illustration of front steering angle versus time of the vehicle of FIG. 7a.

### DETAILED DESCRIPTION

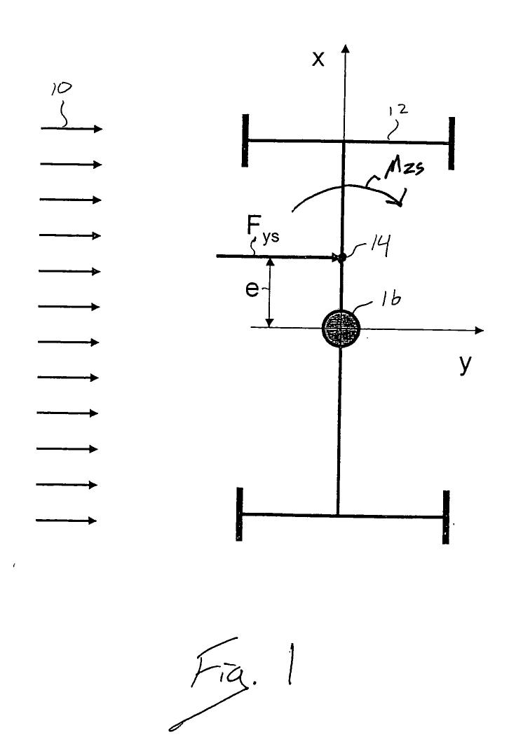

Referring to FIG. 1, side winds 10 may exert an aerodynamic force F_{ys} on a vehicle 12, which may cause unintended lateral deviation of the vehicle 12 from the desired path. The aerodynamic force F_{ys} may be considered as a single force acting at the center of aerodynamic pressure 14. Alternatively, the aerodynamic force F_{ys} may be represented as a combination of a side force F_{ys} acting at the center of mass 16 and an aerodynamic yaw moment M_{zs} represented as follows:

M_{zs}=F_{ys}e (Eq. 1)

wherein e is the distance between the center of mass 16 of the vehicle 12 and the center of aerodynamic pressure 14. In one aspect, for a given vehicle, the distance e may be known, at least approximately, thereby leaving only F_{ys} as the unknown variable.

Under steady-sate conditions, the side force F_{ys} imposed upon the vehicle 12 due to the side winds 10 may be modeled as follows:

$${F}_{ys} = \frac{1}{2} ρ {v}_{w}^{2} {AC}_{S} ( {β}_{w} ) \qquad ( Eq . 2 )$$

and the yaw moment M_{zs} may be modeled as follows:

$${M}_{zs} = \frac{1}{2} ρ {v}_{w}^{2} {ALC}_{M} ( {β}_{w} ) \qquad ( Eq . 3 )$$

wherein ρ is the air density, A is the frontal area of the vehicle 12, ν_{w} is the wind velocity relative to the vehicle, L is vehicle wheelbase, C_{S} and C_{M}, are the side force and the yawing moment coefficients, respectively, both of which may depend upon the relative wind angle β_{w}. Applying Eq. 1 to Eqs. 2 and 3 it can be seen that the side force and the yaw moment coefficients may be proportional to each other as follows:

C_{M}=C_{S}e/L (Eq. 4)

The aerodynamic side force F_{ys} and yaw moment M_{zs} may directly affect the equations for lateral and yaw motions. The magnitudes of the aerodynamic force and moment may depend upon the square of the wind velocity relative to the vehicle 12. Under most driving conditions they may be relatively small and may become significant only when both the vehicle forward speed and the side wind velocity are relatively large.

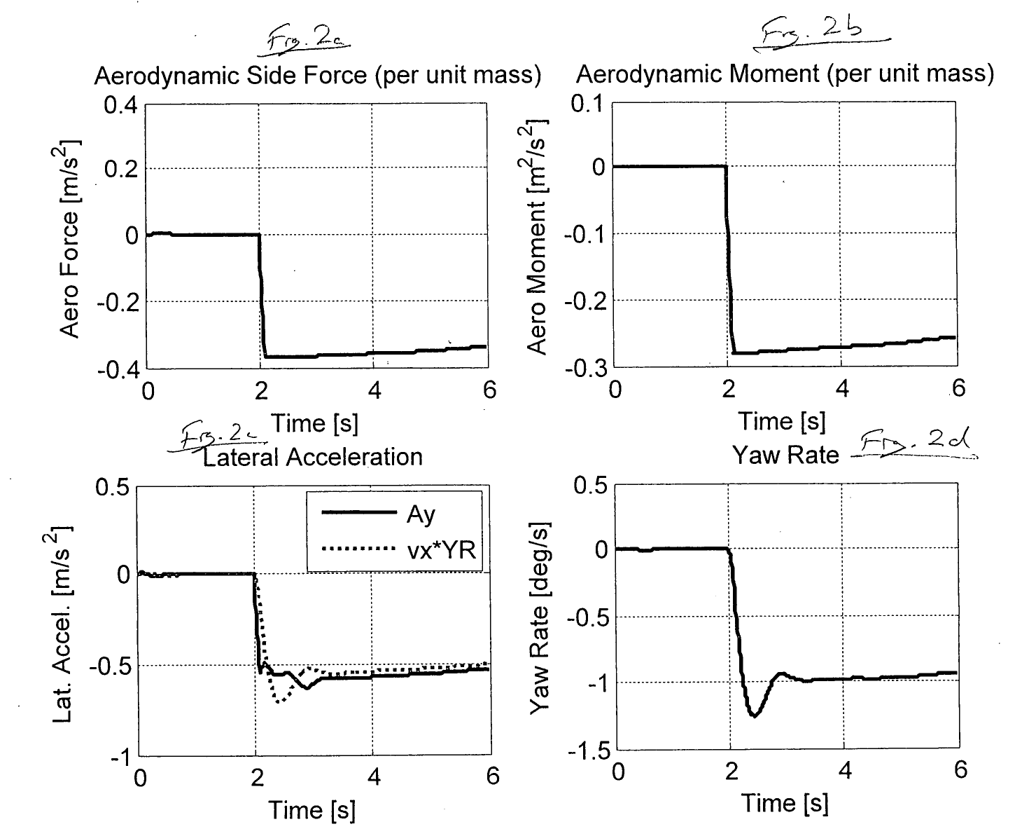

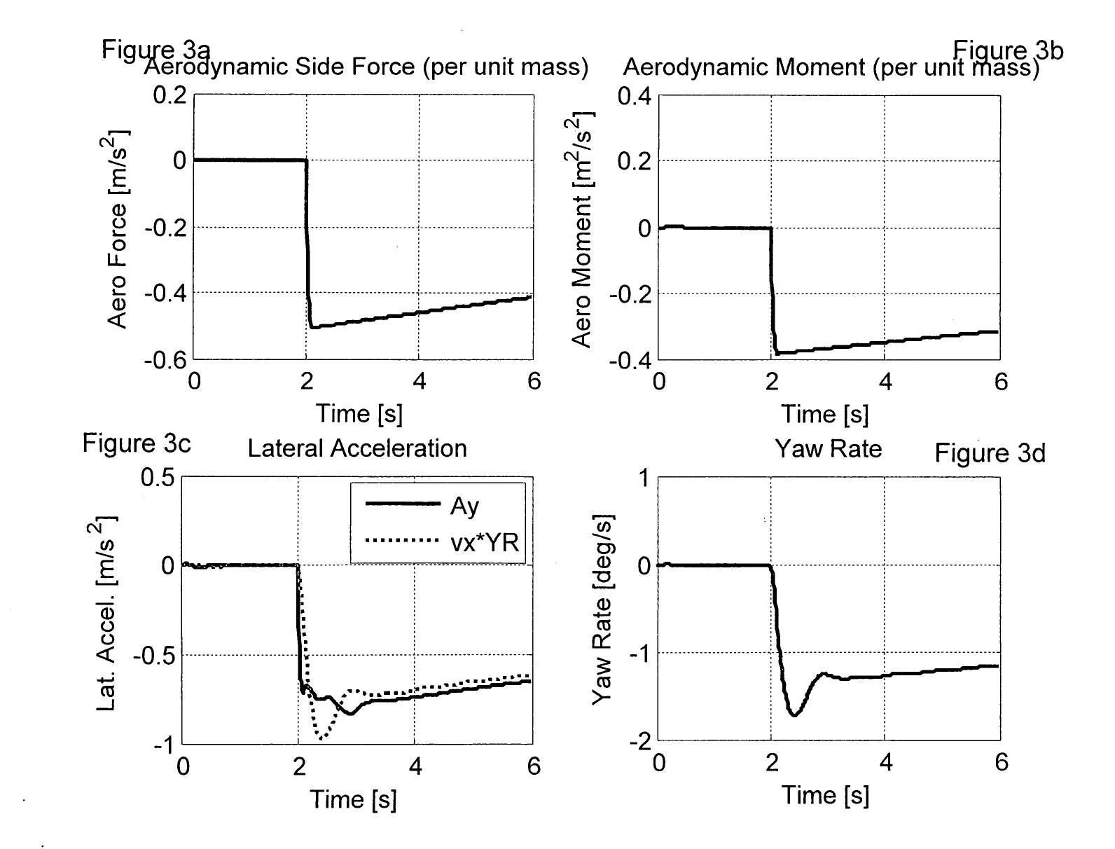

Those skilled in the art will appreciate that the magnitudes of the lateral forces acting on the vehicle seldom exceed 10 percent of the vehicle weight and, therefore, the resulting lateral acceleration response seldom exceeds 0.1 g and the resulting yaw rate is usually below 4 deg/s. For example, referring to FIGS. 2a, 2b, 2c, 2d, 3a, 3b, 3c and 3d, the magnitudes of aerodynamic side force and yaw moment are shown, along with vehicle response during straight driving at 120 kph with side winds of 40 kph and 80 kph occurring after 2 seconds. For the side wind speed of 40 kph (FIGS. 2a, 2b, 2c and 2d), the magnitudes of lateral acceleration and yaw rate are relatively small and may be comparable to sensor errors. However, with the wind speed at 80 kph (FIGS. 3a, 3b, 3c and 3d), the magnitudes of yaw rate and lateral acceleration are large enough to be distinguishable from the normal sensor errors.

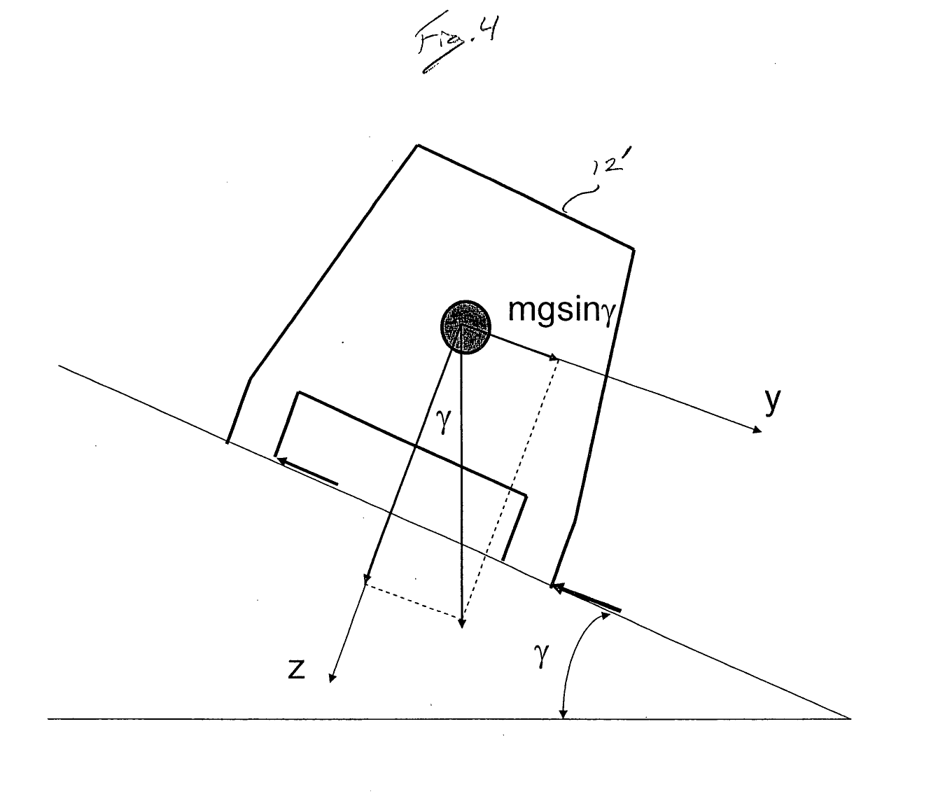

Referring to FIG. 4, a road bank angle γ may also exert a lateral force F_{yg} on a vehicle 12′, which may cause unintended lateral deviation of the vehicle from the desired path. The lateral force F_{yg} due to the bank angle γ may be modeled as follows:

F_{yg}=mg sin γ (Eq. 5)

wherein m is total mass of the vehicle 12′ and g is the acceleration of gravity.

Those skilled in the art will appreciate that there is no yaw moment with respect to the center of gravity. However, the lateral force F_{yg} may directly affect the equation of lateral motion of the vehicle, but only indirectly the yaw motion equation. In addition, the gravity component may directly affect the measured lateral acceleration, since the gravity force may have the same effect on the accelerometer as the inertial force. Thus the measured lateral acceleration a_{ym} may be modeled as follows:

a_{ym}=a_{y}−g sin γ=\dot{ν}_{y}+νₓΩ−g sin γ (Eq. 6)

wherein a_{y} is the actual lateral acceleration, νₓ and ν_{y} are the longitudinal and lateral velocities, respectively, and Ω is the vehicle yaw rate.

In one aspect, the linear bicycle model may be applied, wherein the estimates are more accurate when the vehicle remains within the linear range of handling. Therefore, in addition to the tire forces, the external forces and moment acting on the vehicle 12 may include the lateral force due to side wind F_{ys}, the aerodynamic yawing moment M_{zs} and the lateral force due to the road bank angle F_{yg}. In the linear range of handling, the vehicle dynamics in the yaw plane may be modeled as follows:

$$\begin{matrix}{\dot{v}}_{y} = - \frac{{c}_{f} + {c}_{r}}{{mv}_{x}} {v}_{y} + ( \frac{{c}_{r} b - {c}_{f} a}{{mv}_{x}} - {v}_{x} ) Ω + \frac{{c}_{f}}{m} {δ}_{f} + \frac{{F}_{ys}}{m} + g sin γ & ( Eq . 7 ) \\ \dot{Ω} = \frac{{c}_{r} b - {c}_{f} a}{{I}_{zz} {v}_{x}} {v}_{y} - \frac{{c}_{f} {a}^{2} + {c}_{r} {b}^{2}}{{I}_{zz} {v}_{x}} Ω + \frac{{ac}_{f}}{{I}_{zz}} {δ}_{f} + \frac{e {F}_{ys}}{{I}_{zz}} & ( Eq . 8 )\end{matrix}$$

wherein c_{f} and cᵣ denote cornering stiffness values of both front and both rear tires, respectively, a and b are the distances of the front and rear axles to the center of mass of vehicle, I_{zz} is the vehicle yaw moment of inertia and δ_{f} is the front wheel steering angle.

In one aspect, Eq. 7 may be obtained from the balance of forces in the lateral direction and Eq. 8 may be obtained from the balance of moments about the vertical axis.

Substituting the derivative of lateral velocity \dot{ν}_{y} from Eq. 6 into Eq. 7 and denoting the aerodynamic side force disturbance per unit mass w follows:

$$w = \frac{{F}_{ys}}{m} \qquad ( Eq . 9 )$$

yields the following system of equations:

$$\begin{matrix}{a}_{ym} = - \frac{{c}_{f} + {c}_{r}}{{mv}_{x}} {v}_{y} + \frac{{c}_{r} b - {c}_{f} a}{{mv}_{x}} Ω + \frac{{c}_{f}}{m} {δ}_{f} + w & ( Eq . 10 ) \\ \dot{Ω} = \frac{{c}_{r} b - {c}_{f} a}{{I}_{zz} {v}_{x}} {v}_{y} - \frac{{c}_{f} {a}^{2} + {c}_{r} {b}^{2}}{{I}_{zz} {v}_{x}} Ω + \frac{{ac}_{f}}{{I}_{zz}} {δ}_{f} + \frac{me}{{I}_{zz}} w & ( Eq . 11 )\end{matrix}$$

Since vehicle parameters may be known (at least approximately), the lateral acceleration a_{ym} and the yaw rate Ω may be measured and the vehicle speed νₓ may be estimated, Eqs. 10 and 11 are a system of two equations with only two unknown values, namely lateral velocity ν_{y} and the disturbance w due to the aerodynamic force. Solving Eqs. 10 and 11 for the unknown variables yields:

$$\begin{matrix}{v}_{y} = \frac{\begin{matrix}[ - {mea}_{ym} + {I}_{zz} \dot{Ω} - {c}_{f} ( a - e ) {δ}_{f} ] {v}_{x} + \\ [ {c}_{f} a ( a - e ) + {c}_{r} b ( b + e ) ] Ω\end{matrix}}{{c}_{r} ( b + e ) - {c}_{f} ( a - e )} & ( Eq . 12 ) \\ w = \frac{{F}_{ys}}{m} = {a}_{ym} + \frac{{c}_{f} + {c}_{r}}{{mv}_{x}} {v}_{y} - \frac{{c}_{r} b - {c}_{f} a}{{mv}_{x}} Ω - \frac{{c}_{f}}{m} {δ}_{f} & ( Eq . 13 )\end{matrix}$$

From Eqs. 12 and 13 an estimate of the lateral force disturbance due to side wind F_{ys} can be obtained using only known signals. The time derivative of yaw rate (occurring in Eq. 12) may in practice be approximated by passing the measured yaw rate Ω through a high pass filter in order to reduce the effect of measurement noise. After the lateral force disturbance F_{ys} is determined, the estimate of the yawing moment due to side wind can be determined, if desired, from Eq. 1.

The estimate of bank angle disturbance, g sin γ, can then be obtained from Eq. 6 to yield:

g sin γ=\dot{ν}_{y}+νₓΩ−a_{ym} (Eq. 14)

and the estimate may then be passed through a low pass filter in order to reduce the effect of noise. The derivative of lateral velocity in Eq. 14 may be obtained by differentiating the lateral velocity obtained from Eq. 12. The total lateral force disturbance per unit mass of the vehicle is the sum of the disturbances resulting from the side wind w and due to the bank angle g sin γ.

Those skilled in the art will appreciate that some of the equations described above may be modified to accommodate vehicles equipped with an active rear steer system. For example, when the rear wheels may be steered with an angle δᵣ, Eqs. 10 and 11 may take the following form:

$$\begin{matrix}{a}_{ym} = - \frac{{c}_{f} + {c}_{r}}{{mv}_{x}} {v}_{y} + \frac{{c}_{r} b - {c}_{f} a}{{mv}_{x}} Ω + \frac{{c}_{f}}{m} {δ}_{f} + \frac{{c}_{r}}{m} {δ}_{r} + w & ( Eq . 15 ) \\ \dot{Ω} = \frac{{c}_{r} b - {c}_{f} a}{{I}_{zz} {v}_{x}} {v}_{y} - \frac{{c}_{f} {a}^{2} + {c}_{r} {b}^{2}}{{I}_{zz} {v}_{x}} Ω + \frac{{ac}_{f}}{{I}_{zz}} {δ}_{f} - \frac{{bc}_{r}}{{I}_{zz}} {δ}_{r} + \frac{m e}{{I}_{zz}} w & ( Eq . 16 )\end{matrix}$$

Consequently the term c_{f}(a−e)δ_{f} in Eq. 12 may be replaced with c_{f}(a−e)δ_{f}−cᵣ(b+e)δᵣ and the term

$$\frac{{c}_{f}}{m} {δ}_{f}$$

in Eq. 13 may be replaced with

$$\frac{{c}_{f}}{m} {δ}_{f} + \frac{{c}_{r}}{m} {δ}_{r}$$

to yield the following equations:

$$\begin{matrix}{v}_{y} = \frac{\begin{matrix}[ - {mea}_{ym} + {I}_{zz} \dot{Ω} - {c}_{f} ( a - e ) {δ}_{f} + {c}_{r} ( b + e ) {δ}_{r} ] {v}_{x} + \\ [ {c}_{f} a ( a - e ) + {c}_{r} b ( b + e ) ] Ω\end{matrix}}{{c}_{r} ( b + e ) - {c}_{f} ( a - e )} & ( Eq . 17 ) \\ \begin{matrix}w = \frac{{F}_{ys}}{m} \\ = {a}_{ym} + \frac{{c}_{f} + {c}_{r}}{{mv}_{x}} {v}_{y} - \frac{{c}_{r} b - {c}_{f} a}{{mv}_{x}} Ω - \frac{{c}_{f}}{m} {δ}_{f} - \frac{{c}_{r}}{m} {δ}_{r}\end{matrix} & ( Eq . 18 )\end{matrix}$$

When the vehicle is subjected to a sufficiently large total disturbance and the driver does not provide any significant steering correction, an automatic steering or brake correction may be determined. Since the yaw rate may have a large influence on the vehicle deviation from the desired path in the linear handling range of the vehicle, the correction may be selected to eliminate the steady state value of yaw rate caused by the disturbance. When the vehicle is equipped with either active front steer (AFS) or active rear steer (ARS) system, a front or rear steering correction, respectively, may be applied. If the vehicle posses a brake-based electronic stability control (ESC) system, an asymmetric brake intervention may be initiated.

In one aspect, the objective may be to determine the front steering correction. Therefore, Eq. 9 may be substituted into Eqs. 7 and 8 to yield:

$$\begin{matrix}\begin{matrix}{\dot{v}}_{y} = - \frac{{c}_{f} + {c}_{r}}{{mv}_{x}} {v}_{y} + ( \frac{{c}_{r} b - {c}_{f} a}{{mv}_{x}} - {v}_{x} ) Ω + \\ \frac{{c}_{f}}{m} {δ}_{f} + w + g sin γ\end{matrix} & ( Eq . 19 ) \\ \begin{matrix}\dot{Ω} = \frac{{c}_{r} b - {c}_{f} a}{{I}_{zz} {v}_{x}} {v}_{y} - \frac{{c}_{f} {a}^{2} + {c}_{r} {b}^{2}}{{I}_{zz} {v}_{x}} Ω + \\ \frac{a {c}_{f}}{{I}_{zz}} {δ}_{f} + \frac{me}{{I}_{zz}} w\end{matrix} & ( Eq . 20 )\end{matrix}$$

At steady-state, the time derivatives of lateral velocity and yaw rate may generally equal zero (i.e., \dot{ν}_{y}=0 and \dot{Ω}=0) such that Eqs. 19 and 20 become:

$$\begin{matrix}\frac{{c}_{f} + {c}_{r}}{{mv}_{x}} {v}_{yss} - ( \frac{{c}_{r} b - {c}_{f} a}{{mv}_{x}} - {v}_{x} ) {Ω}_{ss} = \frac{{c}_{f}}{m} {δ}_{f} + w + g sin γ & ( Eq . 21 ) \\ - \frac{{c}_{r} b - {c}_{f} a}{{I}_{zz} {v}_{x}} {v}_{yss} + \frac{{c}_{f} {a}^{2} + {c}_{r} {b}^{2}}{{I}_{zz} {v}_{x}} {Ω}_{ss} = \frac{a {c}_{f}}{{I}_{zz}} {δ}_{f} + \frac{me}{{I}_{zz}} w & ( Eq . 22 )\end{matrix}$$

wherein the symbols ss refer to the steady-state values.

Solving Eqs. 21 and 22 for the unknown values ν_{yss} and Ωₛₛ yields the following steady state value of yaw rate resulting from the disturbances and the front steering correction:

$${Ω}_{ss} = \frac{{v}_{x}}{L + {K}_{u} {v}_{x}^{2}} [ {δ}_{f} + {K}_{u} ( g sin γ + w ) + \frac{me ( {c}_{f} + {c}_{r} )}{{c}_{f} {c}_{r}} w ] \qquad ( Eq . 23 )$$

wherein the symbol L denotes vehicle wheelbase (i.e., L=a+b) and Kᵤ is the understeer gradient, which is given by:

$${K}_{u} = \frac{m ( {c}_{r} b - {c}_{f} a )}{{c}_{f} {c}_{r} L} \qquad ( Eq . 24 )$$

It follows from Eq. 23 that in order to cancel the effect of disturbances on the vehicle yaw rate, the front steering angle correction must be:

$${δ}_{f} = - {K}_{u} ( g sin γ + w ) - \frac{me ( {c}_{f} + {c}_{r} )}{{c}_{f} {c}_{r}} w \qquad ( Eq . 25 )$$

This nominal front steering correction may then be passed through a low pass filter in order to smooth out the command signal and make it more compatible with the dynamics of the steering system. Subsequently, the command may be passed through a high pass filter in order to gradually phase out the steering correction when the disturbance approaches steady-state.

If the vehicle is equipped with an active rear steer system (instead of the active front steer), then following the same approach, the steady-state value of vehicle yaw rate may be:

$${Ω}_{ss} = \frac{{v}_{x}}{L + {K}_{u} {v}_{x}^{2}} [ {δ}_{f} - {δ}_{r} + {K}_{u} ( g sin γ + w ) + \frac{me ( {c}_{f} + {c}_{r} )}{{c}_{f} {c}_{r}} w ] \qquad ( Eq . 26 )$$

wherein δ_{f} is the front steering angle (due to driver steering) and δᵣ is the rear wheel steering angle correction.

In order to cancel the effect of the disturbances, the rear wheel steering correction may be given by the following equation:

$${δ}_{r} = {K}_{u} ( w + g sin γ ) + \frac{me ( {c}_{f} + {c}_{r} )}{{c}_{f} {c}_{r} L} w \qquad ( Eq . 27 )$$

If the vehicle is not equipped with an active steering system, but features a brake-based ESC system, then an automatic brake system intervention can be used instead of steering angle correction. In this case the corrective yaw moment may be generated by applying the difference in braking forces between the left and right sides of the vehicle (i.e., ΔF_{xLR}). During driving in the linear handling range, this brake intervention may impart the yaw moment to vehicle, which may be given by the following equation:

$${M}_{zcor} = - \frac{1}{2} Δ {F}_{xLR} {t}_{w} \qquad ( Eq . 28 )$$

wherein t_{w} denotes the track width.

The vehicle may then be subjected to two yawing moments: M_{zs}=F_{ys}e=mew (Eq. 1) due to side wind and the corrective moment M_{zcor} (Eq. 28). Therefore, Eq. 23 for the steady-state value of yaw rate may be modified by replacing the yaw moment mew in the last term by the sum of moments mew−0.5ΔF_{xLR}t_{w}. This yields:

$$\begin{matrix}{Ω}_{ss} = \frac{{v}_{x}}{L + {K}_{u} {v}_{x}^{2}} [ {δ}_{f} + {K}_{u} ( g sin γ + w ) + \\ \frac{( {c}_{f} + {c}_{r} )}{{c}_{f} {c}_{r}} ( mew - \frac{1}{2} Δ {F}_{xLR} {t}_{w} ) ]\end{matrix} \qquad ( Eq . 29 )$$

Requiring that the braking correction ΔF_{xLR} cancels the effect of disturbances on the steady state value of yaw rate yields the following value of the brake force difference:

$$Δ {F}_{xLR} = \frac{2}{{t}_{w}} [ mew + {K}_{u} \frac{{c}_{f} {c}_{r} L}{{c}_{f} + {c}_{r}} ( w + g sin γ ) ] \qquad ( Eq . 30 )$$

Using Eq. 24, the above equation can be written as:

$$Δ {F}_{xLR} = \frac{2}{{t}_{w}} [ ew + \frac{{c}_{r} b - {c}_{f} a}{{c}_{f} + {c}_{r}} ( w + g sin γ ) ] \qquad ( Eq . 31 )$$

The difference in braking forces may be expressed in terms of the difference in the wheel circumferential speeds, since the latter is often more convenient to use. In the linear range of tire operation, the longitudinal tire force may be a linear function of tire longitudinal slip:

$$Δ {F}_{xLR} = - {c}_{x} \frac{Δ {v}_{LR}}{{v}_{x}} \qquad ( Eq . 32 )$$

wherein cₓ denotes the longitudinal tire stiffness and Δν_{LR} is the difference in circumferential speeds of left and right wheels. The minus sign suggests that during braking of the left wheels a negative difference between the speed of the left and right wheels may be generated.

It follows from Eq. 32 that the difference in longitudinal tire forces given by Eq. 31 corresponds to the commanded difference between the (circumferential) speeds of left and right wheel Δν_{LR}:

$$Δ {v}_{LR} = - \frac{2 {mv}_{x}}{{t}_{w} {c}_{x}} [ ew + \frac{{c}_{r} b - {c}_{f} a}{{c}_{f} + {c}_{r}} ( w + g sin γ ) ] \qquad ( Eq . 33 )$$

The relationships described above may form the basis for estimating and rejecting disturbances associated with side wind and changes in road bank angle.

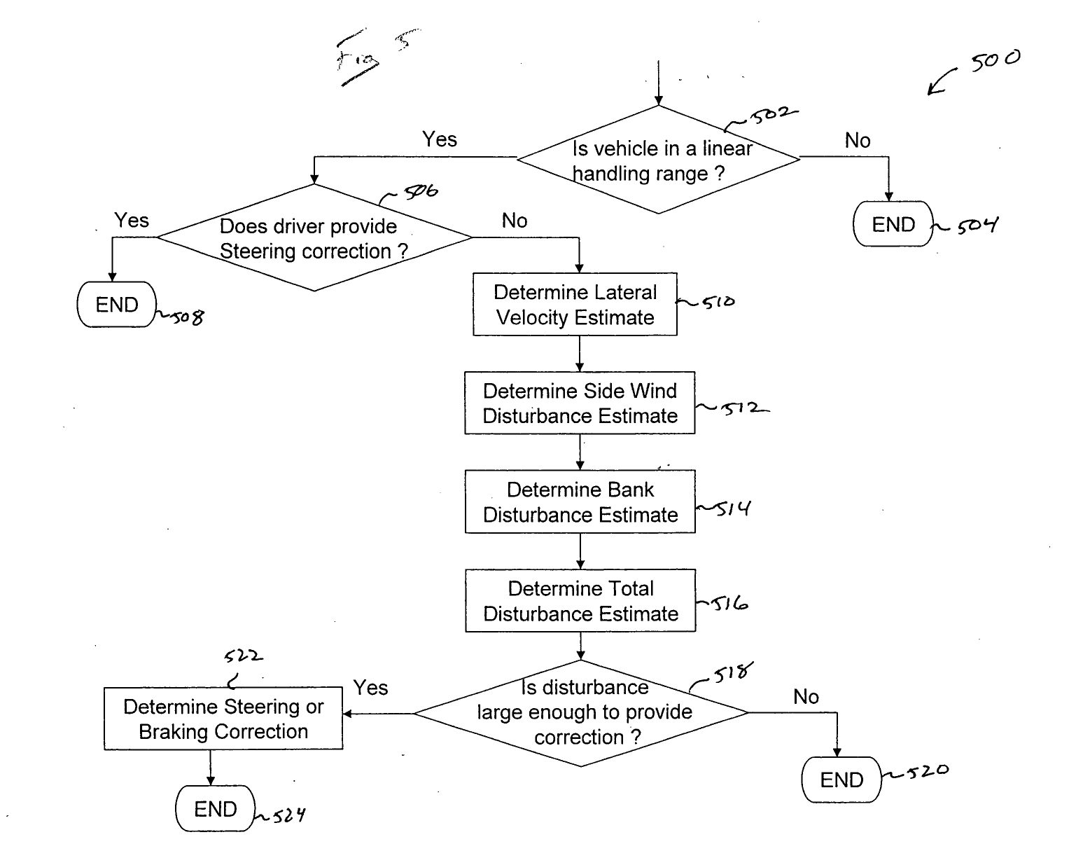

Referring to FIG. 5, one aspect of the disclosed system and method for estimating and compensating for lateral disturbances, generally designated 500, is provided. At block 502, the system may determine whether the vehicle is in the linear handling range. If the vehicle is in the linear handling range, the process may continue, if not, the process may end at block 504.

The system may determine whether the vehicle is in the linear handling range by evaluating the magnitude of the product of yaw rate and speed, νₓΩ, and possibly the measured lateral acceleration, a_{ym}. If the values are small enough (e.g., less than about 2 m/s²), the vehicle may be in the linear range of handling. Additional conditions may be considered, for example, the magnitude of the difference between the desired and measured yaw rates should be small enough (e.g., less than about 4 deg/s).

At block 506, the system may determine whether the driver has provided a significant steering correction. This may be accomplished by evaluating the magnitude and the rate of change of the steering angle inputted by the driver. If both are below their respective thresholds, the system may conclude that the driver has not provided a sufficient steering correction. In one aspect, the thresholds may be speed dependent. In another aspect, the magnitude and the rate of change of the desired yaw rate may be used, which may be derived from the steering angle and speed.

Thus, if the driver provides correction, there may be no need for additional system correction and, therefore, the process may end at block 508. However, if the driver does not provide correction, the system may continue to block 510 and may begin the estimation process.

At block 510 the process may determine the estimate of lateral velocity ν_{y} using, for example, the measured lateral acceleration a_{y}, yaw rate Ω, front wheel steering angle δ_{f}, the rear wheel steering angle δᵣ, estimated vehicle speed νₓ and/or any other known parameters of vehicle. In one aspect, the lateral velocity may be computed from Eqs. 12 and/or 17.

At block 512, the process may determine the estimate of the lateral force disturbance due to the side wind using, for example, measured lateral acceleration a_{ym}, yaw rate Ω, and estimated longitudinal and lateral velocities νₓ and ν_{y}.

The lateral force disturbance due to the side wind per unit mass of vehicle w may be determined from Eq. 13 and, if desired, the yaw moment disturbance due to side wind may be computed from Eq. 1. If the vehicle is equipped with an active rear steer system, then Eq. 13 may be replaced with Eq. 18.

At block 514, the process may determine the estimate of the lateral force disturbance in the form of a gravity component due to the bank angle of the road g sin γ. In one aspect, the process may use the following signals and Eq. 14 to estimate the lateral force disturbance associated with the road bank angle: measured yaw rate Ω, lateral acceleration a_{ym} and the estimated vehicle longitudinal and lateral velocities νₓ and ν_{y}. The estimate may be passed through a low pass filter to reduce the effect of noise.

At block 516, the process may determine the total lateral force disturbance estimate (per unit mass) as the sum of the lateral force due to crosswind w and the gravity component due to the bank angle g sin γ.

At block 518, the process may determine whether the magnitude and the rate of change of the lateral disturbances are sufficiently large to warrant the automatic intervention of the control system.

For example, the magnitude of total disturbance estimate, |w+g sin γ|, and/or its rate of change must exceed threshold values. A combination of the magnitude of total disturbance and its rate of change may be considered. If the condition is not satisfied, the steering correction or a brake intervention may not be applied and the process may end at block 520. If the magnitude is sufficient to warrant intervention, the process may proceed to block 522.

At block 522, the process may determine the magnitude and/or the direction of the steering correction or brake intervention necessary to counter the effect of the lateral disturbance.

In one aspect, the nominal front steering correction may be determined from Eq. 25. This nominal front steering correction may then be passed through a low pass filter in order to smooth out the command signal and make it more compatible with the dynamics of the steering system. Subsequently, the command may be passed through a high pass filter in order to gradually phase out the steering correction when the disturbance approaches steady-state. An example of such filter is the one with a transfer function of s/(s+p) where s is the Laplace operand and p=0.3 rad/s, though those skilled in the art will appreciate that this may be achieved in numerous different ways.

If an automatic brake system intervention is used instead of steering angle correction, then the corrective yaw moment may be generated based upon the difference in braking forces between the left and right side of vehicle ΔF_{xLR}. In one aspect, this difference, if expressed in terms of braking forces, may be given by Eq. 31. In another aspect, Eq. 33 may be used with the difference in wheel speeds Δv_{LR}.

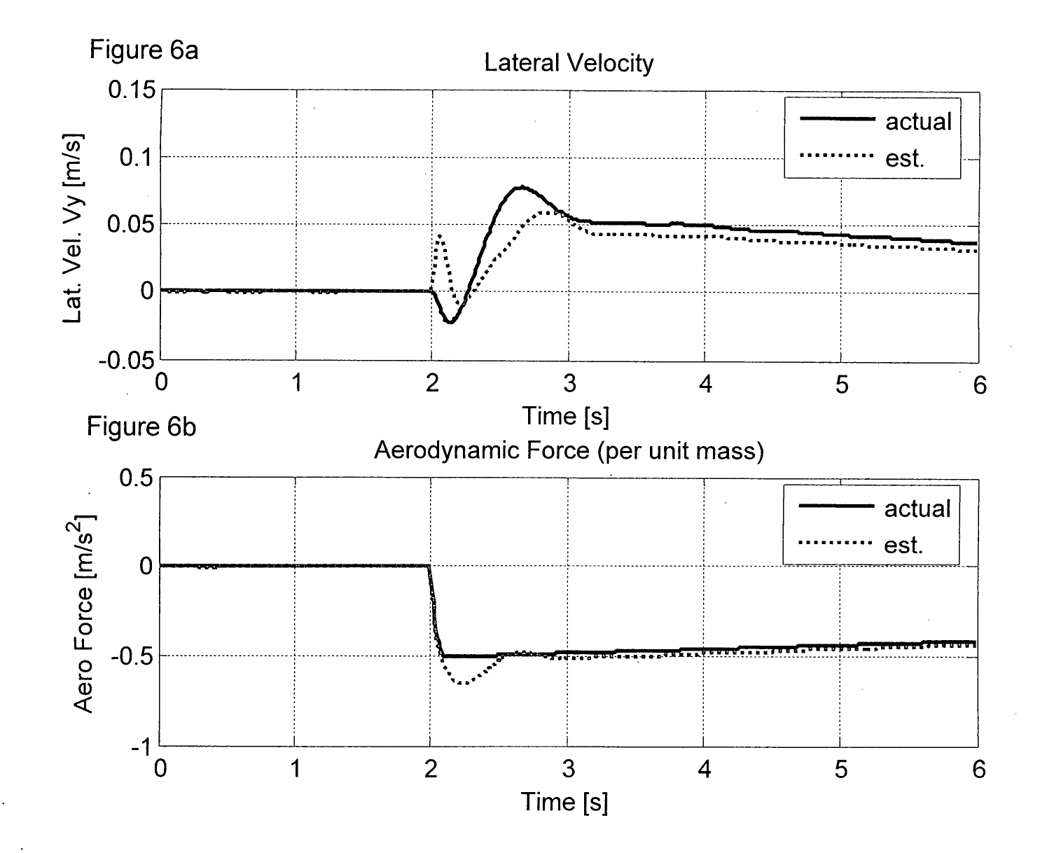

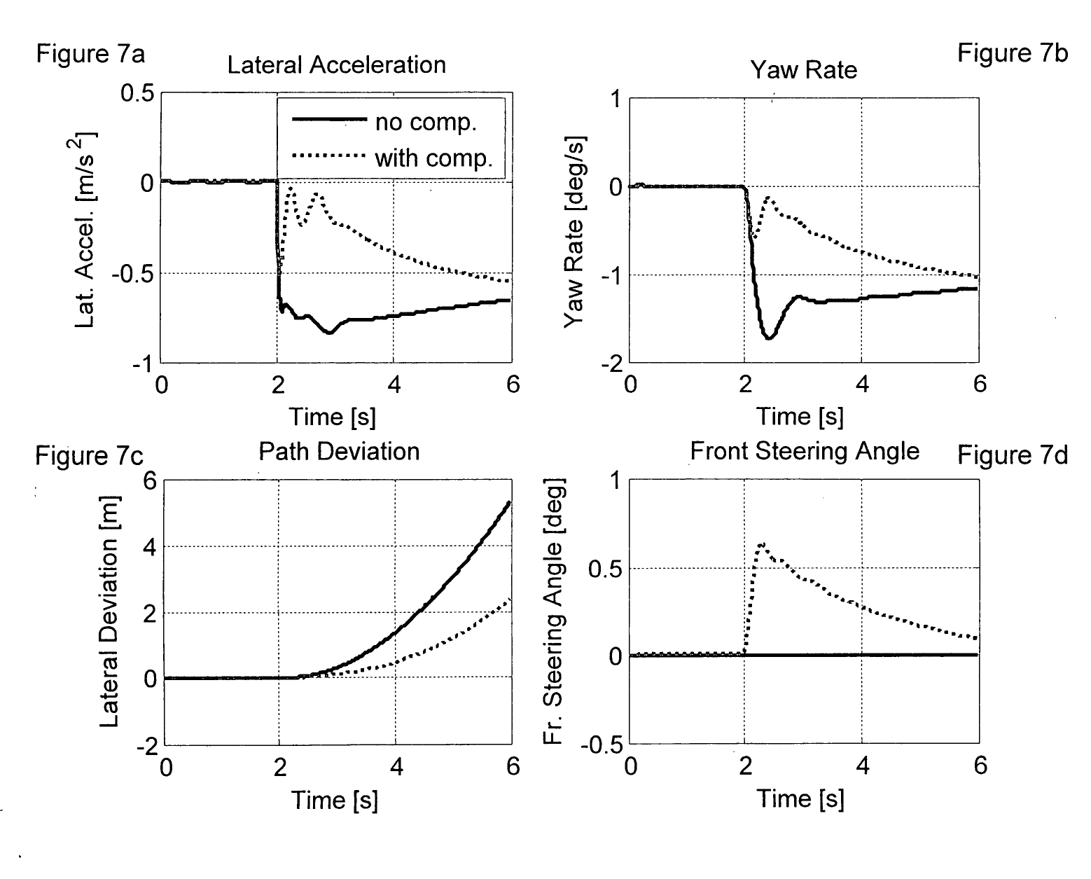

FIGS. 6a, 6b, 7a, 7b, 7c and 7d provide example results of the application of the above algorithm to a vehicle in high-fidelity simulation. The vehicle was driven straight at about 120 kph when, at 2 seconds into the simulation, the vehicle entered a crosswind having a speed of about 80 kph. In FIG. 6a, the actual and estimated values of lateral velocity of the vehicle are shown with the estimated value determined by the disclosed method. In FIG. 6b, the actual and estimated values of lateral force disturbance of vehicle are shown with the estimated value determined by the disclosed method. The estimate of lateral force disturbance, which is used in the proposed compensation method, is quite accurate. In FIGS. 7a-7d, vehicle responses are illustrated for a conventional vehicle without any disturbance compensating system and a vehicle with disturbance compensation using the disclosed method. Traces of vehicle lateral acceleration (FIG. 7a), yaw rate (FIG. 7b), lateral path deviation (FIG. 7c) and front steering angle (FIG. 7d) are shown. In both cases it was assumed that the driver does not provide any steering correction. Immediately after the disturbance impacts the vehicle, the front steering correction reaches the maximum magnitude of about 0.7 degrees, which is sufficient to almost completely compensate the effect of the disturbance on vehicle lateral acceleration and yaw rate. Subsequently, the steering correction is gradually reduced, since the driver is expected to react 1 to 2 seconds after the disturbance affects the vehicle motion. In the first two seconds after the disturbance impacts the vehicle, the system reduces the lateral deviation from the desired path at least three-fold as compared with a vehicle without compensation, thereby giving the driver more time to react and to remain within the same lane.

Thus, the disclosed system may provide temporary support to the driver when a sudden gust of wind and/or a change in the bank angle of the road causes a significant lateral deviation from the desired path. After a predetermined amount of time, the disclosed system may return control to the driver.

In one aspect, the disclosed system does not require any expensive vision/optical systems. Therefore, the disclosed system may not add any additional hardware beyond what is already available on a vehicle equipped with an ESC system and/or a controlled steering system (e.g., active front steer, active rear steer or electric power steer). The only addition may be software.

Although various aspects of the disclosed estimation and compensation system and method have been shown and described, modifications may occur to those skilled in the art upon reading the specification. The present disclosure includes such modifications and is limited only by the scope of the claims.

What is claimed is:

1. A method for compensating for a lateral force disturbance acting on a vehicle comprising the steps of:
estimating a magnitude of said lateral force disturbance;
determining whether at least one of said magnitude and a rate of change of said magnitude exceeds a predetermined threshold value; and
when said predetermined threshold value is exceeded, generating a control signal adapted to at least partially counter said lateral force disturbance.

2. The method of claim 1 wherein said lateral force disturbance includes at least one of a side wind component and a gravity component.

3. The method of claim 2 wherein at least one of said wind component and said gravity component is passed through a filter to reduce noise.

4. The method of claim 1 wherein said estimating step includes estimating a lateral velocity of said vehicle and said estimate of said lateral force disturbance is based, at least in part, upon said estimate of said lateral velocity.

5. The method of claim 4 wherein said lateral velocity is estimated using at least one of a measured lateral acceleration, a yaw rate, a front wheel steering angle, a rear wheel steering angle and a vehicle speed.

6. The method of claim 1 wherein said control signal is at least one of a steering correction signal and a brake intervention signal.

7. The method of claim 6 further comprising communicating said steering correction signal to a controlled steering system.

8. The method of claim 7 wherein said controlled steering system is at least one of an active front steer system, an active rear steer system and an electric power steer system.

9. The method of claim 6 further comprising communicating said brake intervention signal to a controlled braking system.

10. The method of claim 9 wherein said controlled braking system is a brake-based electronic stability control system.

11. The method of claim 1 wherein said generating step includes determining at least one of a magnitude and a direction of said control signal necessary to at least partially counter said lateral force disturbance.

12. The method of claim 1 wherein said control signal is adapted to counter said lateral force disturbance only for a pre-determined amount of time.

13. The method of claim 1 further comprising, prior to said generating step, determining whether said vehicle is in a linear range of handling.

14. The method of claim 1 further comprising, prior to said generating step, determining whether a driver steering correction has been provided in response to said lateral force disturbance.

15. A method for compensating for a lateral force disturbance acting on a vehicle comprising the steps of:
estimating a lateral velocity of said vehicle based upon at least one of a measured lateral acceleration, a yaw rate, a front wheel steering angle, a rear wheel steering angle and a vehicle speed;
based at least upon said estimated lateral velocity, estimating a magnitude and a direction of said lateral force disturbance acting on said vehicle;
determining whether at least one of said magnitude and a rate of change of said magnitude exceeds a predetermined threshold value; and
when said predetermined threshold value is exceeded, providing said vehicle with at least one of a steering correction and a brake intervention to at least partially counter said magnitude and said direction of said lateral force disturbance.

16. The method of claim 15 wherein said lateral force disturbance includes at least one of a side wind component and a gravity component.

17. The method of claim 15 wherein at least one of said wind component and said gravity component is passed through a filter to reduce noise.

18. The method of claim 15 wherein said at least one of said steering correction and said brake intervention is provided for a pre-determined amount of time.

19. The method of claim 15 further comprising, prior to said providing step, determining whether said vehicle is in a linear range of handling.

20. The method of claim 15 further comprising, prior to said providing step, determining whether a driver steering correction has been provided in response to said lateral force disturbance.
